(19) United States
(12) Patent Application Publication
(10) Pub. No.: US 2005/0017525 A1
(43) Pub. Date: Jan. 27, 2005

(54) Auxiliary handle assembly for hand tool

(76) Inventor: Maurice J. Douziech, Edmonton (CA)

Correspondence Address: JEAN M. MACHELEDT, 501 SKYSAIL LANE, SUITE B100, FORT COLLINS, CO, 80525-3133, US

(21) Appl. No.: 10/872,655

(22) Filed: Jun. 21, 2004

Related U.S. Application Data
(63) Continuation-in-part of application No. 10/660,874, filed on Sep. 12, 2003.

(30) Foreign Application Priority Data
Jul. 21, 2003 (CA) 2,435,638

(51) Int. Cl. A01B 1/22

(52) U.S. Cl. 294/58

(57) ABSTRACT

The present invention is concerned with an auxiliary handle assembly having a rotatable handgrip for hand tools having a longitudinal shaft such as rakes, forks, hooks, cultivators, hoes, shovels, scoops, spoons, scrapers, edgers, brooms and floor squeegees. In the preferred embodiment of the present invention, the auxiliary handle assembly is an inverted U-shaped rod having two legs and a handle portion, whereupon the lower ends of the legs are pivotally attached to the tool head of the hand tool. Alternatively, the handle assembly may comprise a single leg that is pivotally attached to the tool head. In the preferred embodiment, each leg of the handle assembly is capable of adjusting in length. When the hand tool is to be put away for storage, or when it is more convenient to use the tool in a conventional manner, a handle clip temporarily secures the handgrip of the handle assembly to the shaft of the hand tool.

### CROSS REFERENCE TO RELATED APPLICATION

This application is a continuation-in-part of pending U.S. application Ser. No. 10/660,874 awarded a filing date of 12 Sep. 2003 as filed on behalf of the applicant hereof, which claimed the benefit under 35 U.S.C. §119 of Canadian Application N^{o.} 2,435,638 filed by the applicant on 21 Jul. 2003.

### FIELD OF THE INVENTION

The present invention relates to the field of auxiliary handle assemblies for use with hand tools. More specifically, the present invention relates to auxiliary handle assemblies having rotatable handgrips for use with shovels, rakes, brooms and the like.

### BACKGROUND

The concept of auxiliary handles for hand tools is not new. For example, many instances of two-handled shovels exist in the prior art. Some examples include accessory handles that attach to the shaft of a conventional shovel whereas other examples may comprise a second handle or shaft or a flexible cord attached to the juncture of the shovel blade and the shaft allowing the shovel to be used with both hands. The second handle provides the ability to apply extra leverage and force to the shovel in lifting and/or moving the load carried by the shovel. The second handle also permits a person to lift or move a heavier load without having to stoop or bend over and grasp the shovel handle near the blade. In moving snow, for example, the snow may be laden with moisture and be very heavy to move. Moving snow under these conditions can be very strenuous and hard on a person's arms and back.

As two-handled shovels are supported by both hands, each handle of the shovel moves along separate paths or arcs as determined by the length of a person's arms. If each handle is gripped tightly in order to move a heavy load with the shovel blade, each hand must turn, at the wrist, in the direction the shovel is being moved. One hand will turn inward at the wrist whereas the other will turn outward at the wrist. This may cause pain and discomfort if the shovel is being used to move heavy or multiple loads.

It is, therefore, desirable to have an auxiliary handle assembly for use with garden implements where the hand gripping the auxiliary handle assembly does not need to bend or turn at the wrists when lifting or moving a load with the garden implement.

### SUMMARY

The present invention is concerned with an auxiliary handle assembly for hand tools such as garden implements, brooms and the like, the assembly having a rotatable handgrip. The type of hand tool expected to use the present invention will include, but is not limited to, the class of hand tools known as rakes, forks, hooks, cultivators, hoes, shovels, scoops, spoons, scrapers, edgers, rotary edgers, brooms and floor squeegees. In all cases, the hand tool comprises a longitudinal shaft having upper and lower ends whereby the lower end of the shaft is operatively attached to the tool head of the hand tool.

In the preferred embodiment of the present invention, the auxiliary handle assembly is an inverted U-shaped rod having two legs and a handle portion for attaching to the tool head of the garden implement. The assembly further comprises a pivot bracket for attaching to the tool head of the garden implement. Depending on the type of implement being used, the pivot bracket may be a single bracket having left and right tabs defining a pivot axis. Alternatively, the pivot bracket may comprise individual left and right tabs that amount separately to the tool head of the implement while still forming a pivot axis. The lower ends of the legs of the handle assembly are pivotally attached to the pivot tabs mounted on the tool head of the garden implement thereby allowing the handle assembly to be capable of pivoting forwards and backwards about the pivot axis. The handle portion further comprises a tubular handgrip surrounding said handle portion whereby the handgrip is capable of rotating about the handle portion.

In another embodiment of the present invention, each leg of the handle assembly is capable of adjusting in length. Each leg is comprised of an upper and lower leg member. The upper leg members and the handle portion are formed from a single piece of solid rod. A rotatable handgrip, such as a piece of thick-walled tube or sleeve, is slipped over the rod to the handle portion before the rod is bent into a U-shaped piece. At the lower end of each upper leg member is a long nut welded to the rod wherein the axis of the nut aperture is parallel to the axis of the rod. Each lower leg is a piece of threaded rod that threads into the long nut. The overall length of each leg is then determined by the amount each lower leg is threaded into the long nut. The lower end of each lower leg is bent into an L-shape and placed through an aperture in a pivot tab. A nut is then threaded on to the end of each lower leg to retain the lower leg to the pivot tab and permits the auxiliary handle assembly to pivot about the pivot axis.

In another embodiment of the present invention, both the upper and lower leg members are made from threaded rod. The upper leg member and handle portion would be made from rod having right-handed threads whereas the lower legs would be made from rod having left-handed threads. The converse could be true as well. To connect the upper legs to the lower legs, a sleeve having internal right-handed threads at one end and internal left-handed threads at the other end are used to couple the upper and lower legs together on each side of the second handle assembly by threading the upper and lower legs into the sleeve. Similar to a turnbuckle, turning the sleeve clockwise or counterclockwise will either shorten or lengthen the overall length of each leg of the second handle assembly.

In another embodiment, both the upper and lower legs are made from threaded rod having right-handed threads. Two long nuts are welded together to form a coupling nut that fastens the upper and lower legs together. The upper leg threads into one of the long nuts of the coupling nut from one end whereas the lower legs threads into the other long nut from the opposite end.

In yet another embodiment, the upper and lower legs are slidably connected to one another in a telescoping fashion. The legs comprise a plurality of pinholes placed in a spaced-apart fashion along the longitudinal length of the legs. Telescoping the upper and lower legs to one another until a pinhole on both legs line up sets the overall length of the leg portion. A pin is placed through the pinholes of both legs to secure the length. A hitch pin clip is used to keep the pin in place.

An alternate embodiment of the present invention may comprise the auxiliary handle assembly having a single leg portion. Preferably, the upper leg is an inverted L-shaped leg with a handle portion having a rotatable handgrip. The lower leg attaches to the tool head at a pivot point. The lower leg is connected at the pivot point using a universal joint assembly that allows the auxiliary handle assembly to pivot in all directions about the pivot point. Alternatively, the lower leg is connected at the pivot point using a ball joint assembly that also allows the auxiliary handle assembly to pivot in all directions about the pivot point. In either case, the auxiliary handle assembly operates and functions similar to the two-legged version of the present invention described above.

When the hand tool is to be put away for storage, or when the hand tool is to be used in a conventional manner without resorting to the auxiliary handle assembly, a handle clip is used to temporarily secure the handgrip of the auxiliary handle assembly to the shaft of the hand tool. The handle clip comprises back-to-back horseshoe-shaped clips that are fastened to one another such that the opening of one clip is orthogonal to the other. The handle clip is simply snapped onto the handgrip of the auxiliary handle assembly and is then snapped onto the shaft of the hand tool as the assembly is pivoted toward the shaft.

Broadly stated, one aspect of the present invention is an auxiliary handle assembly for a hand tool having a longitudinal shaft with upper and lower ends, the lower end operatively attached to a tool head, the assembly comprising: left and right pivot tabs operatively connected to said tool head, said pivot tabs defining a pivot axis; an upper assembly comprising of left and right leg portions each having upper and lower ends, and a handle portion extending between said upper ends of said leg portions, said handle portion defining a handle axis, said lower ends of said leg portions adapted to pivotally attach to said pivot tabs whereby said upper assembly is capable of pivoting about said pivot axis; and a hand grip pivotally attached to said handle portion, said hand grip capable of rotating about said handle axis.

Broadly stated, another aspect of the present invention is a handle clip for removably attaching a handgrip of an auxiliary handle assembly to a shaft of a hand tool, said auxiliary handle assembly pivotally attached to a tool head of said hand tool, said handle clip comprising: a first clip having a first opening suitable for removably attaching to said shaft and a first back opposing said first opening; and a second clip having a second opening suitable for removably attaching to said handgrip and a second back opposing said second opening, said second clip attached to said first clip whereby said first back is abutting said second back and whereby said first and second clips are substantially orthogonal to one another.

Broadly stately, another aspect of the present invention is an auxiliary handle assembly for a hand tool having a longitudinal shaft with upper and lower ends, the lower end operatively attached to a tool head, the assembly comprising: a pivot tab operatively connected to said tool head, said pivot tab defining a pivot point; an upper assembly comprising of a leg portion having upper and lower ends, and a handle portion extending from the upper end of said leg portion, said handle portion defining a handle axis, said lower end of said leg portion adapted to pivotally attach to said pivot tab whereby said upper assembly is capable of pivoting about said pivot point; and a hand grip pivotally attached to said handle portion, said hand grip capable of rotating about said handle axis.

### BRIEF DESCRIPTION OF THE DRAWINGS

FIG. 1A is perspective view of one embodiment of the present invention as mounted on a snow shovel.

FIG. 1B is a perspective of an alternate embodiment of the present invention as mounted on a snow shovel.

FIG. 1C is a close-up exploded view of one embodiment of the pivot attachment mechanism of the present invention.

FIG. 1D is a close-up view of the leg length adjustment mechanism of the alternate embodiment of the present invention.

FIG. 2 is a side elevational view of the present invention as mounted on a snow shovel.

FIG. 3 is an exploded perspective view of the present invention as mounted on a snow shovel.

FIG. 4A is close-up exploded view of the present invention as mounted on a snow shovel blade.

FIG. 4B is close-up exploded view of an alternate pivot attachment mechanism of the present invention.

FIG. 5A is close-up exploded view of the present invention as mounted on a scoop shovel in the first alternate embodiment.

FIG. 5B is a close-up exploded view of the present invention as mounted on a scoop shovel in the second alternate embodiment.

FIG. 5C is a close-up exploded view of the present invention as mounted on a scoop shovel in the third alternate embodiment.

FIG. 6A is a close-up exploded view of the present invention as mounted on a fork in one embodiment.

FIG. 6B is a close-up exploded view of the present invention as mounted on a fork in an alternate embodiment.

FIG. 7A is a close-up exploded view of the present invention as mounted on a rake in the first alternate embodiment.

FIG. 7B is a close-up exploded view of the present invention as mounted on a rake in the second alternate embodiment.

FIG. 7C is a close-up exploded view of the present invention as mounted on a rake in the third alternate embodiment.

FIG. 7D is a close-up exploded view of the present invention as mounted on a rake in the fourth alternate embodiment.

FIG. 8A is a close-up exploded view of the present invention as mounted on a hook in one embodiment.

FIG. 8B is a close-up exploded view of the present invention as mounted on a hook in an alternate embodiment.

FIG. 9 is a close-up exploded view of the present invention as mounted on a scraper.

FIG. 10 is a close-up exploded view of the present invention as mounted on an edger.

FIG. 11 is a close-up exploded view of the present invention as mounted on a rotary edger.

FIG. 12A is a close-up exploded view of the present invention as mounted on a hoe in one embodiment.

FIG. 12B is a close-up exploded view of the present invention as mounted on a hoe in an alternate embodiment.

FIG. 13 is a close-up view of the leg length adjustment mechanism of the first embodiment of the present invention.

FIG. 14 is a cutaway view of the handgrip of the present invention.

FIG. 15 is an exploded perspective view of a second alternate embodiment of the present invention as mounted on a snow shovel.

FIG. 16 is a close-up view of the leg length adjustment mechanism of the second alternate embodiment of the present invention.

FIG. 17 is an exploded perspective view of a third alternate embodiment of the present invention as mounted on a snow shovel.

FIG. 18 is a close-up view of the leg length adjustment mechanism of the third alternate embodiment of the present invention.

FIG. 19 is a close-up view of the present invention as mounted on a broom.

FIG. 20 is a close-up view of the present invention as mounted on a floor squeegee.

FIG. 21 is an exploded perspective view of a fourth alternate embodiment of the present invention as mounted on a snow shovel.

FIG. 22 is an exploded perspective view of a fifth alternate embodiment of the present invention as mounted on a snow shovel.

FIG. 23 is an exploded perspective view of a sixth alternate embodiment of the present invention as mounted on a snow shovel.

FIG. 24 is a close-up view of the handle clip of the present invention.

### DETAILED DESCRIPTION OF THE PREFERRED EMBODIMENT

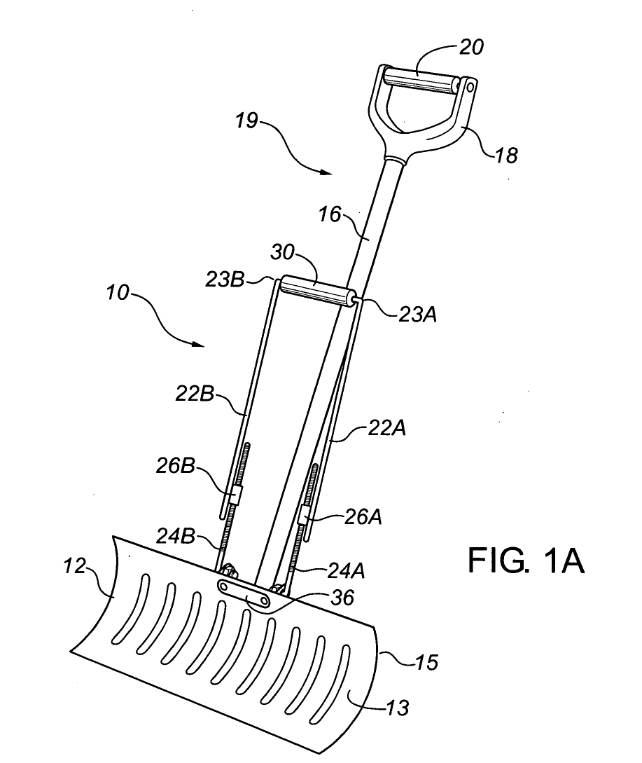

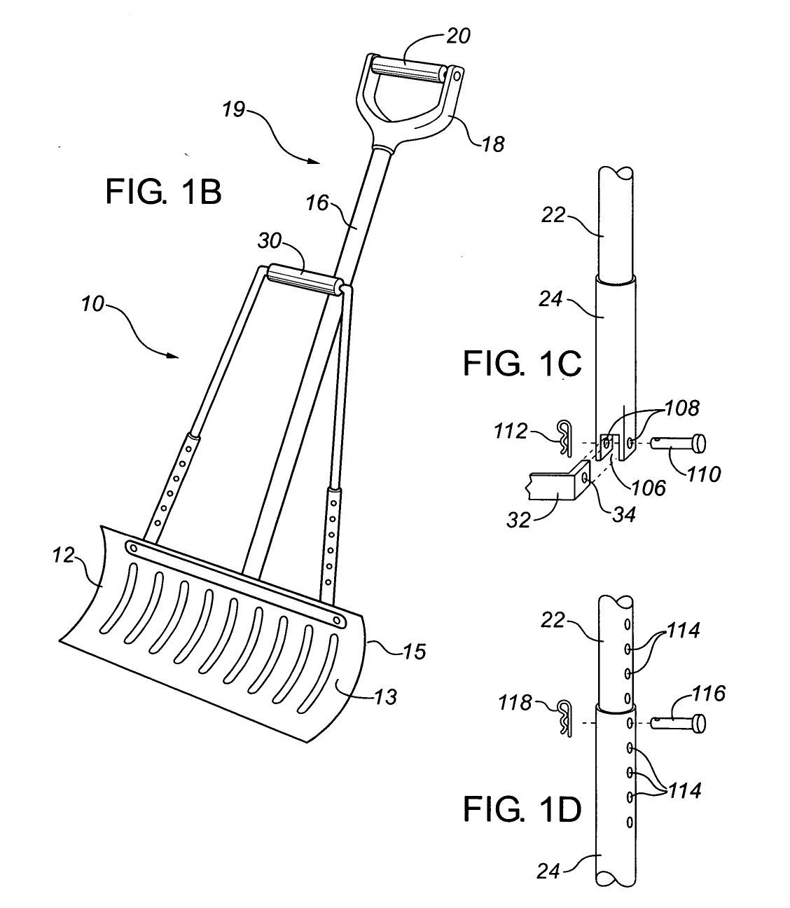

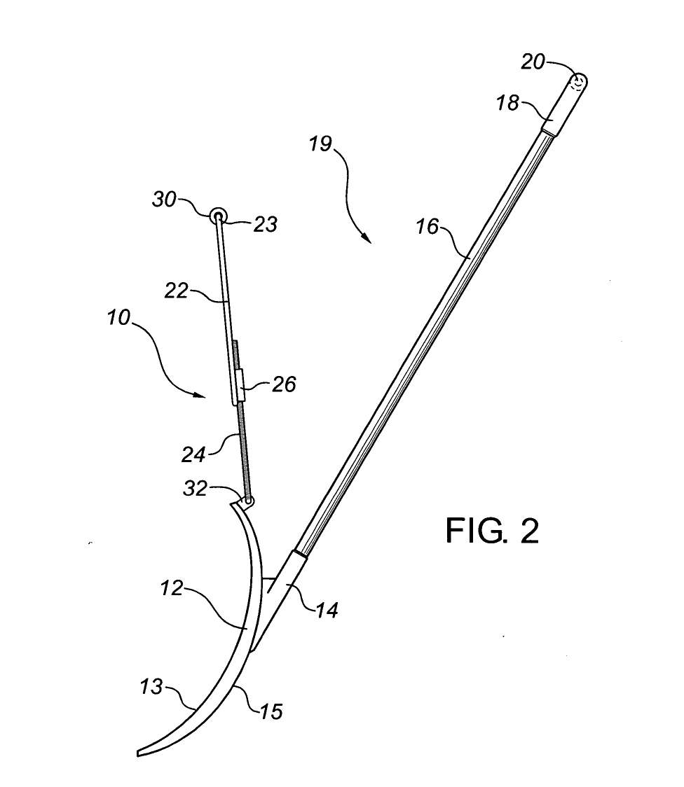

The present invention is concerned with an auxiliary handle assembly having a rotatable handgrip for use with a hand tool. As shown in FIGS. 1A and 2, handle assembly 10 of the present invention is illustrated as attached to snow shovel 19. Shovel 19 comprises a blade 12 having a concave front surface 13 and a convex rear surface 15. On rear surface 15 is shaft insert sleeve 14, which receives the lower end of shaft 16. Handle 18 is mounted on the upper end of shaft 16. Handle 18 is preferably a D-shaped handle and has rotatable handgrip 20. Mounted on blade 12 is U-shaped pivot bracket 32. Attached to pivot bracket 32 is handle assembly 10. Handle assembly 10 comprises of upper leg members 22A and B, lower leg members 24A and B and handgrip 30.

Referring to FIGS. 1B and 1C, an alternate embodiment of the present invention is shown. In this embodiment, lower leg members 24 are splayed apart to nearly the width of blade 12. Lower legs 24 comprise yokes 106 which are used to pivotally connect to bracket 32. Pin 110 passes through holes 108 of yoke 106 and holes 34 of bracket 32. Pin clip 112 secures pin 110 into position.

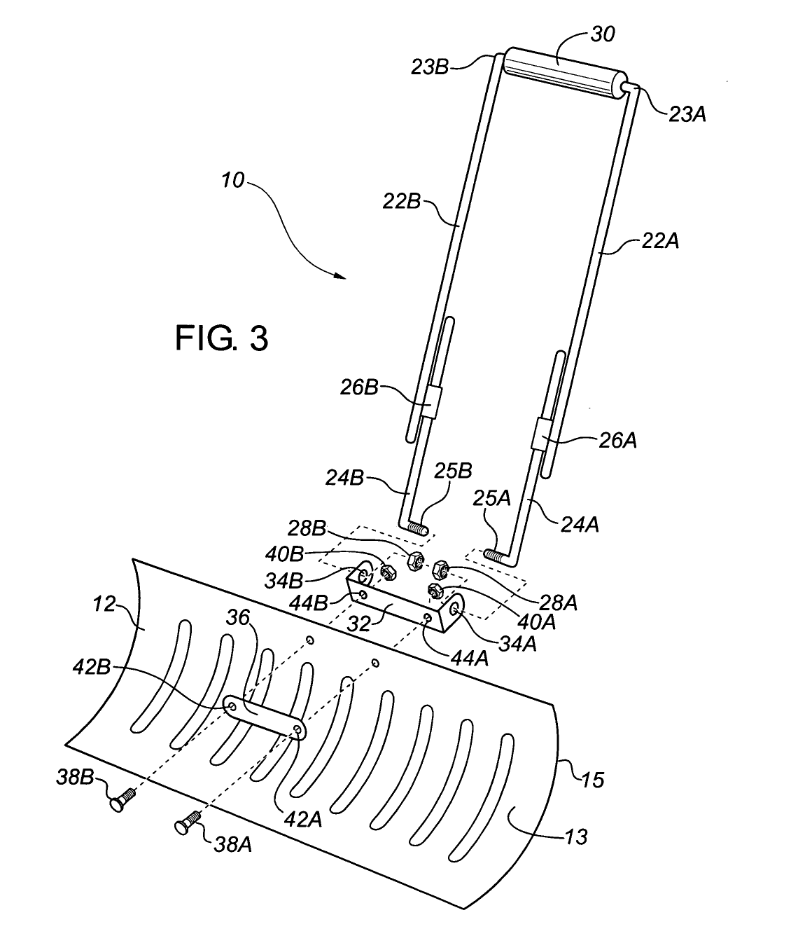

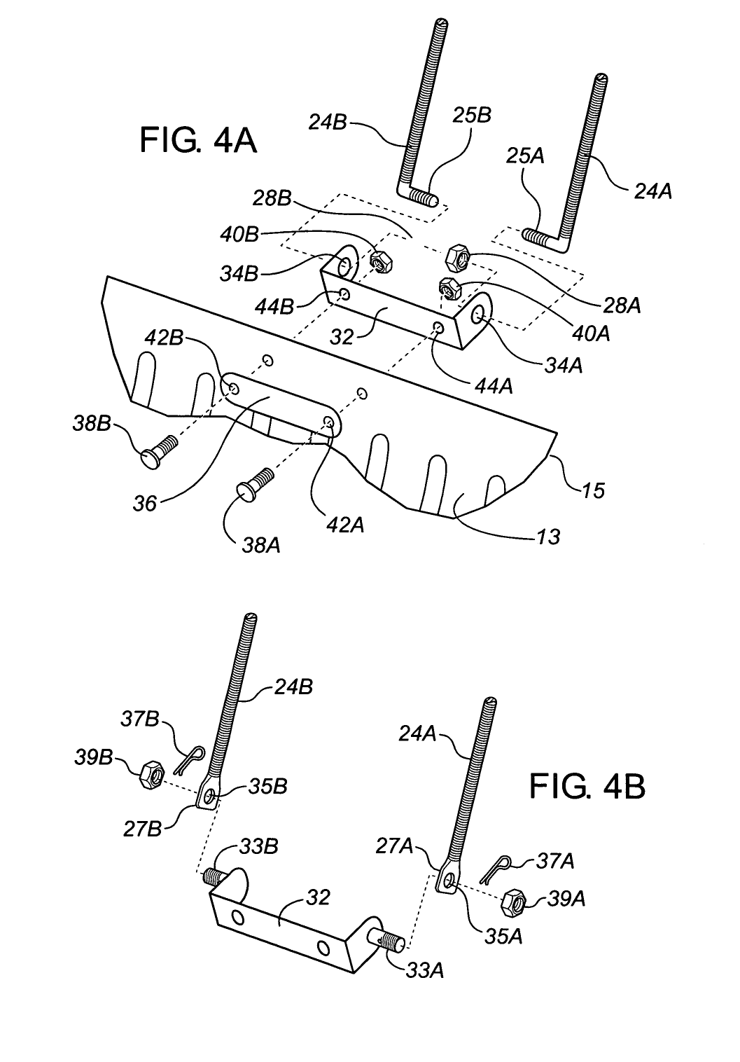

Referring to FIGS. 3 and 4A, bracket 32 is bolted to blade 12 by bolts 38A and B passing through apertures 42A and B of backing plate 36, through corresponding apertures in blade 12, through apertures 44A and B of pivot bracket 32 and secured by nuts 40A and B. Lower legs 24A and B are made of threaded rod whose lower ends are bent 90 degrees into ends 25A and B. Preferably, lower legs 24A and B are made of threaded rod and upper legs-22 A and B are made of solid rod. The diameter of the threaded and solid rods may range from ¼″ to ⅜″ depending on the application and the strength required for handle assembly 10. Ends 25A and B pass through apertures 34A and B of bracket 32 and are secured with nuts 28A and B. Preferably, nuts 28A and B are aircraft-style or self locking nuts. Referring to FIG. 4B, an alternate embodiment of attaching handle assembly 10 to a hand tool is shown. In this embodiment, bracket 32 comprises pins 33A and B in place of apertures 34A and B. Correspondingly, lower legs 24A comprise tabs 27A and B having apertures 35A and B in place of bends 25 and B. Once bracket 32 is attached to a hand tool, handle assembly 10 is pivotally attached to said hand tool by passing pins 33A and B through apertures 35A and B of tabs 27A and B that are then secured by either cotter pins 37A and B or nuts 39A and B. In the examples to follow, it is anticipated that handle assembly 10 may be, alternatively, pivotally attached to the hand tools described using the embodiment described in this paragraph.

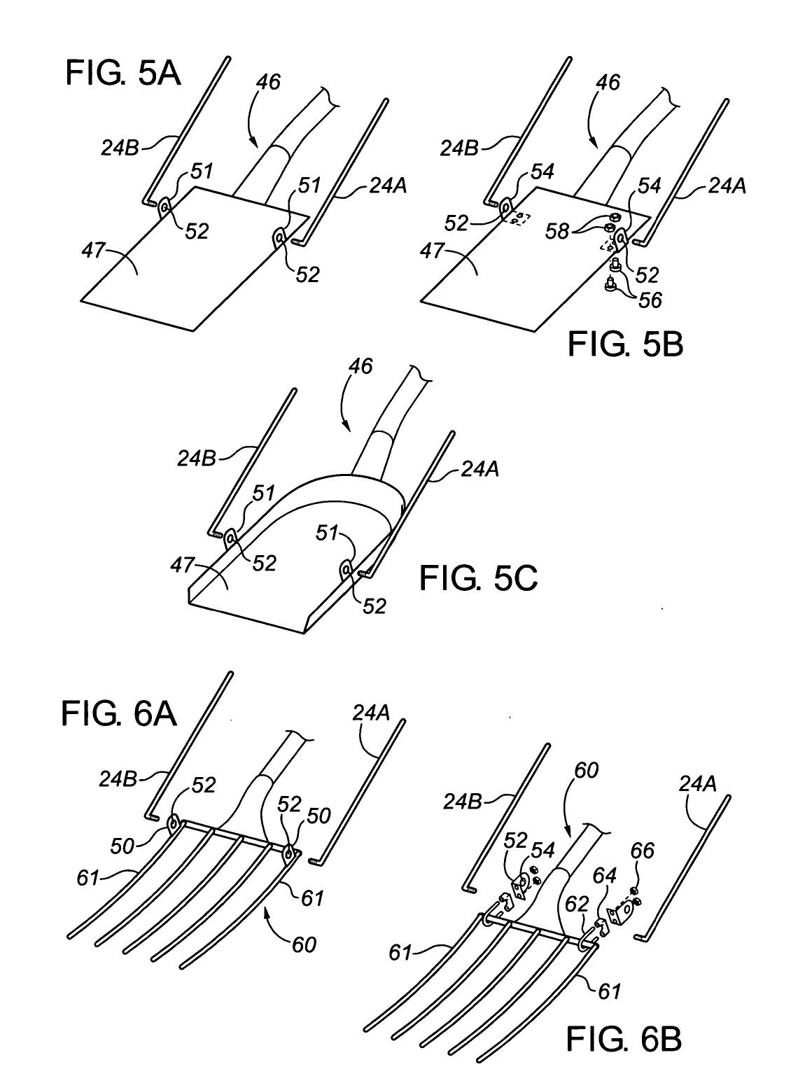

Referring to FIGS. 5A, 5B, and 5C, alternate embodiments of attaching handle assembly 10 to shovel 46 are illustrated. In FIG. 5A, bracket 32 is replaced with ears 51 which form part of scoop 47. Apertures 52 in ears 51 define pivot axis 11 and received bends 25A and B of lower legs 24A and B. In FIG. 5B, bracket 32 is replaced with tabs 54 which are, preferably, L-shaped and are attached to scoop 47 with bolts 56 and nuts 58 or with rivets (not shown). Alternatively, tabs 54 may be welded or spot-welded to scoop 47.

In FIG. 5C, shovel 46 is shown with ears 51 positioned near the leading edge of scoop 47. By positioning ears 51 in this fashion, the efficiency and effectiveness of handle assembly 10 is improved when shoveling materials such as grain. Preferably, ears 51 would be placed approximately 3″ from the leading edge of scoop 47.

Referring to FIGS. 6A and 6B, alternate embodiments of attaching handle assembly 10 to fork 60 are illustrated. In FIG. 6A, fork 60 comprises ears 51 which are formed part of tines 61. Ears 51 comprise apertures 52 to define pivot axis 11 and to receive bends 25A and B of lower legs 24A and B. In FIG. 6B, bracket 32 is replaced with tabs 54 which are fastened to tines 61 with U-bolts 62, clamp 64 and nuts 66.

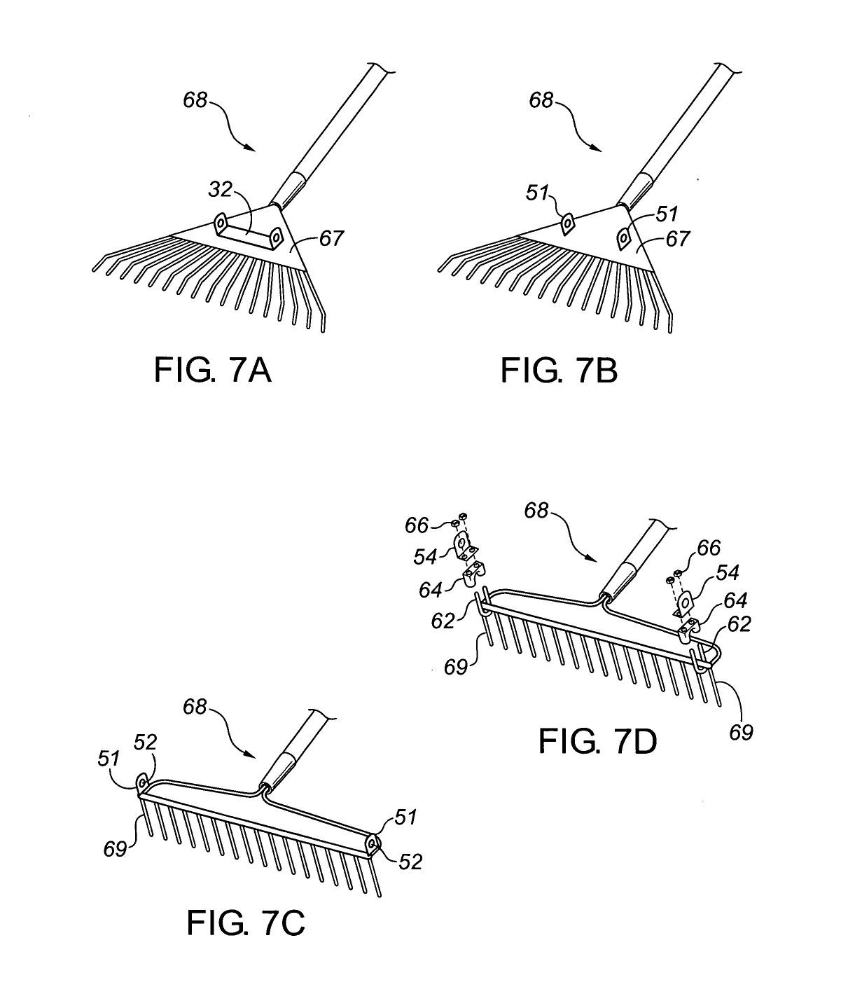

Referring to FIGS. 7A, 7B, 7C and 7D, embodiments of the present invention for use with rake 68 are shown. In FIG. 7A, bracket 32 is attached to rate 68 using fasteners as known to those skilled in the art (not shown). If rake 68 is made of metal, brackets 32 may be welded to rake head 67. Similar to the aforementioned embodiments, handle assembly 10 is then pivotally attached to bracket 32.

Referring to FIG. 7B, the second embodiment of rake 68 is shown with ears 51 formed as part of rake head 67. If rake head 67 is molded from plastic, then ears 51 may be formed as part of the molded piece. If rake head 67 is made of metal, then ears 51 may be formed by punching rake head 67 and bending ears 51 up using metal stamping techniques as well known by those skilled in the art.

Referring to FIG. 7C, a third embodiment of rake 68 is shown with ears 58 being formed as part of rake head 69. Alternatively, tabs 54 may be mounted to rake head 69 using U-bolts 62, clamp 64 and nuts 66 as shown in FIG. 7D.

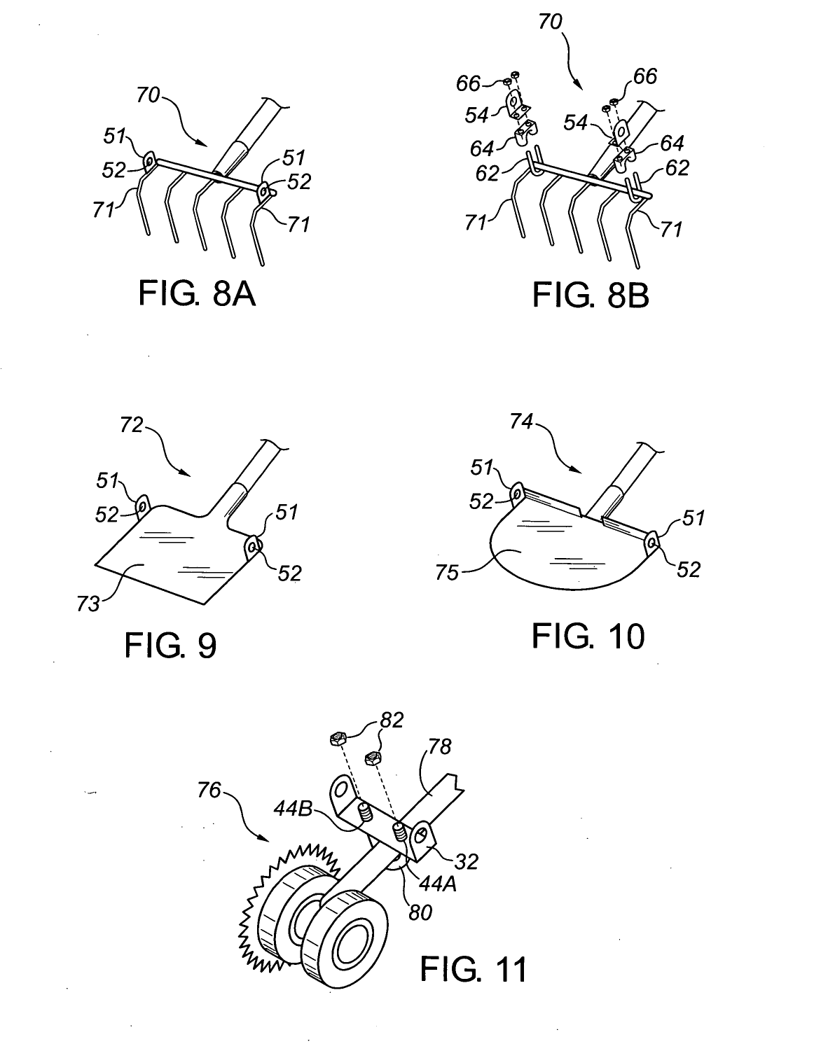

Referring to FIGS. 8A and 8B, alternate embodiments of attaching handle assembly 10 to hook 70 is shown. Similar to that of fork 60, FIG. 8A shows ears 51 forming part of tines 71 for defining pivot axis 11 and for receiving bends 25A and B of lower legs 24A and B. In FIG. 8B, bracket 32 is replaced with tabs 54 which are mounted to tines 71 using U-bolts 62, clamp 64 and nuts 60.

Referring to FIG. 9, an embodiment to the present invention for use with scraper 72 is shown. In this embodiment, blade 73 of scraper 72 comprises of ears 51 having apertures 52 to form pivot axis 11 and to receive bends 25A and B of lower legs 24A and B. Although not shown, scraper 72 may, alternatively, have tabs 52 fastened to blade 73 similar to that of shovel 46 as shown in FIG. 6B.

Referring to FIG. 10, an embodiment of the present invention for use with edger 74 is shown. In this embodiment, blade 75 of edger 74 comprises ears 51 having apertures 52 to form pivot axis 11 and to receive bends 25A and B of lower legs 24A and B. Although not shown, edger 74 may, alternatively, have tabs 52 fastened to blade 75 similar to that of shovel 46 as shown in FIG. 6B.

Referring to FIG. 11, an embodiment of the present invention for use with rotary edger 76 is shown. In this embodiment, bracket 32 is mounted to shaft 78 of rotary edger 76 using U-bolt 80 that passes around shaft 78 and through apertures 44 and B of bracket 32 to be secured by nuts 82.

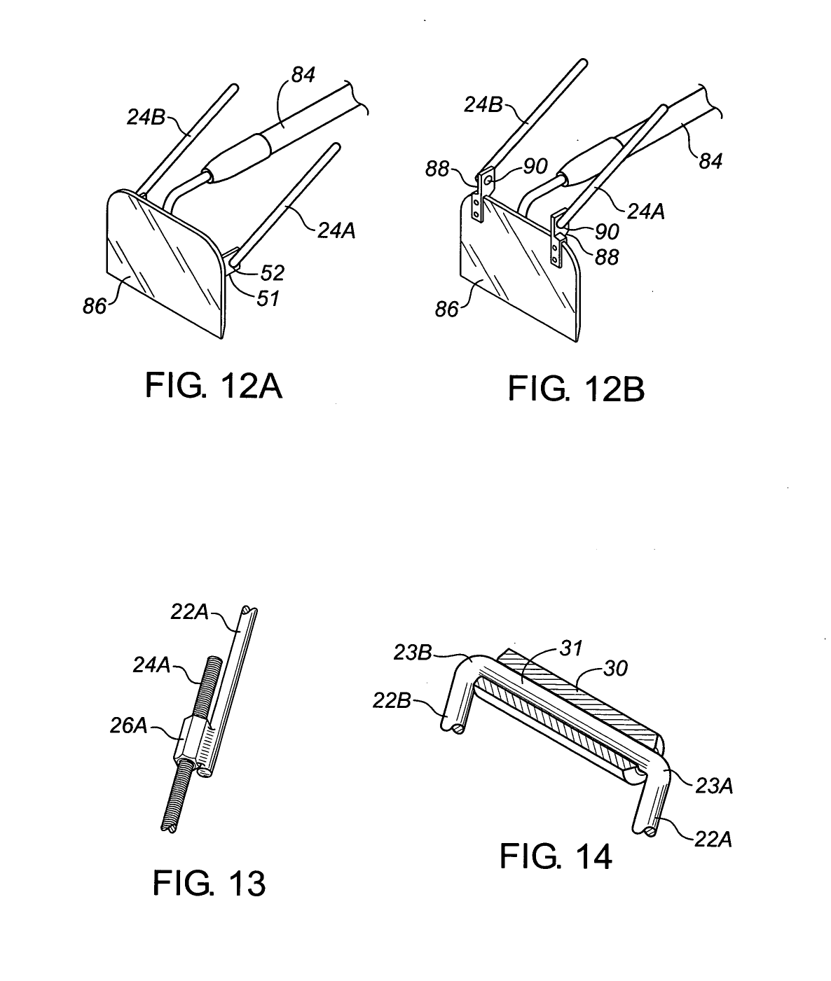

Referring to FIGS. 12A and 12B, alternate embodiments of attaching handle assembly 10 to hoe 84 is shown. In FIG. 12A, blade 86 is formed with ears 51 having apertures 52 to form pivot axis 11 and to receive bends 25A and B of lower legs 24A and B. In FIG. 12B, tabs 88 which may be formed from flat strips of metal such that the opposing ends are turned approximately 90° with respect to each other, are fastened to blade 86 using fasteners or by being welded or spot welded in place. Tabs 88 have apertures 90 to pivot axis 11 and to receive bends 25A and B of lower legs 24A and B.

The preferred embodiment of the present invention permits the overall length of handle assembly 10 to be adjusted. As shown in FIG. 5, the lower end of upper leg 22 has long nut 26 attached to it, preferably welded. The axis of nut 26 is parallel to the axis of upper leg 22. Lower leg 24 is threaded into nut 26. The overall length of handle assembly 10 is governed by the amount of lower leg 24 is threaded into nut 26.

As shown in FIG. 14, one preferred embodiment of handle assembly 10 has the handle portion and both upper legs 22A and B formed from a single piece of rod 31. Grip 30 is a cylindrical tube made up of material suitable for gripping. Grip 30 is slid onto rod 31 prior to rod 31 being bent with 90° corners 23A and B thereby containing grip 30 onto handle assembly 10. Grip 30 is free to rotate on rod 31.

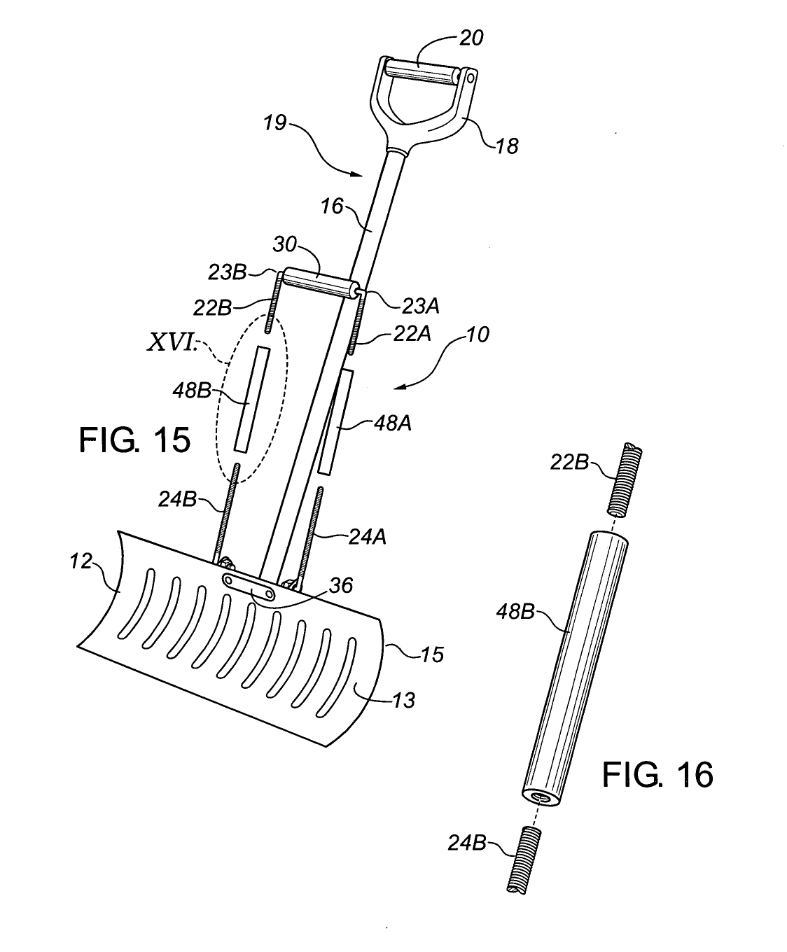

In an alternate preferred embodiment, as shown in FIGS. 15 and 16, upper legs 22A and B are formed from a piece of right-hand threaded rod, and lower legs 24A and B are formed from left-hand threaded rod, both upper and lower legs are preferably made from ¼″ to ⅜″ diameter threaded rod. Alternatively, upper legs 22A and B can have left-hand threads and lower legs 24A and B can have right-hand threads. Sleeves 48A and B are then used to couple the upper and lower legs together. Sleeves 48A and B have internal right-hand threads at one end and internal left-hand threads at the other end. Upper legs 22A and B and lower legs 24A and B are then threaded into the appropriate end of sleeves 48A and B. Operating similar to that of a turnbuckle, the length of the legs of handle assembly 10 is adjusted by turning sleeves 48A and B clockwise or counter-clockwise.

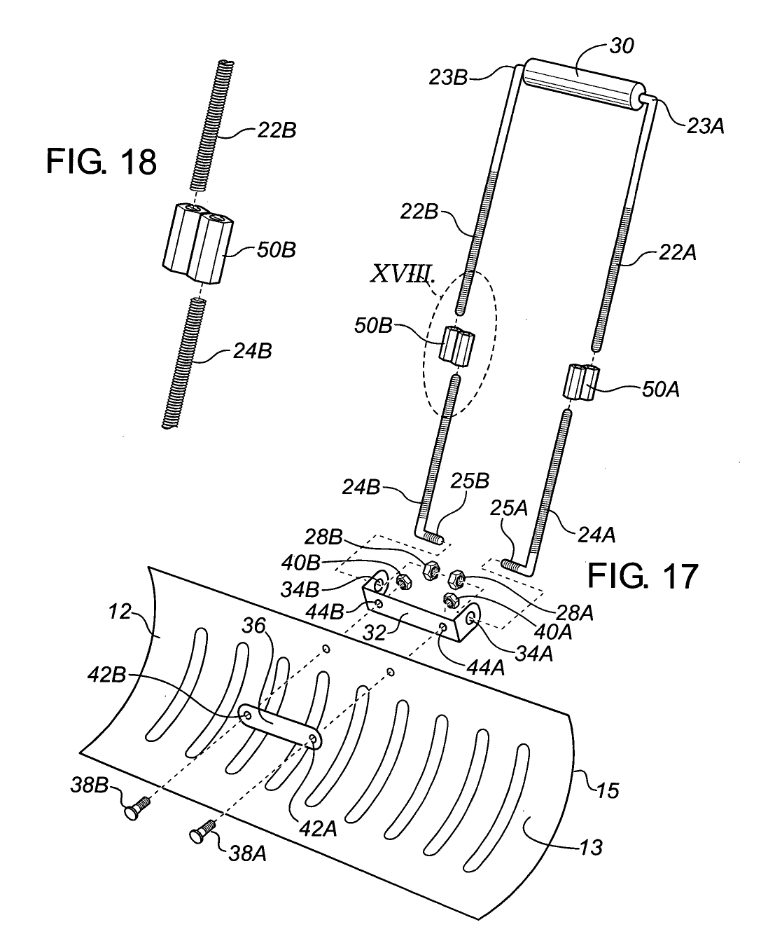

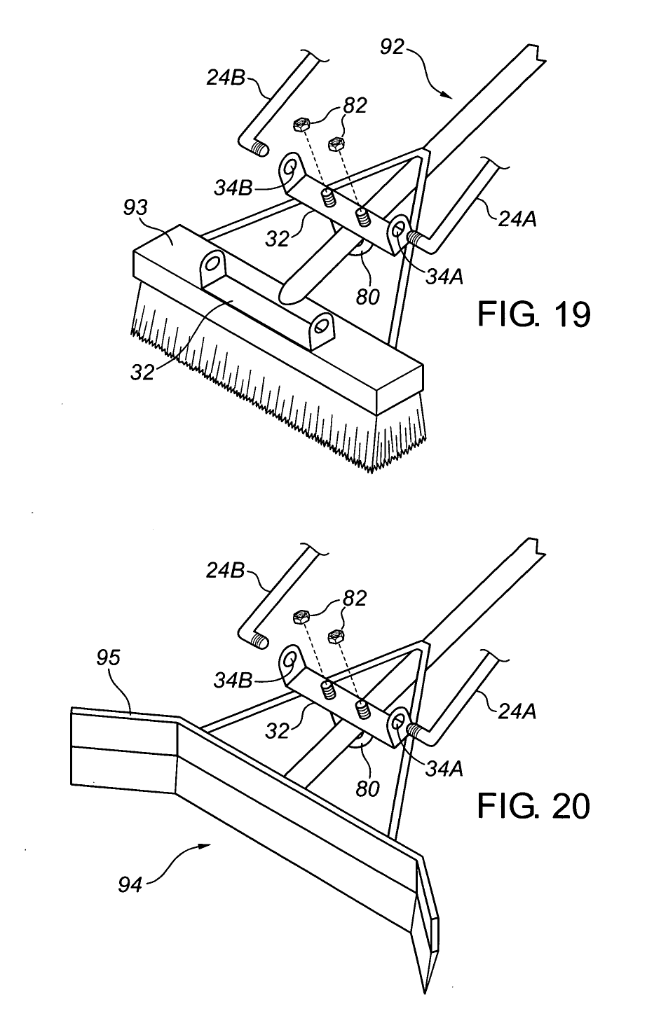

In another preferred embodiment, as shown in FIGS. 17 and 18, upper legs 22A and B and lower legs 24A and B are made from threaded rod having right handed threads, preferably ¼″ to ⅜″ in diameter. Coupling nuts 50A and B are used to join the upper and lower leg members together and to permit adjustment of the overall length of the handle assembly 10. Coupling nut 50 consists of two long nuts 26 welded together side by side. Upper leg 22 threads into one nut of coupler nut 50 from one end while lower leg 24 threads into the other nut of coupler nut 50 from the opposite end. The overall length of each leg of handle assembly 10 is determined by the amount upper leg 22 and lower leg 24 are threaded into coupler nut 50 prior to attaching end 25 to aperture 34 of bracket 32.

Referring to FIG. 1D, another embodiment of the leg length adjustment mechanism is shown. Upper and lower legs 22 and 24 are slidably connected to one another to operate in a telescoping fashion. In this embodiment, each of upper and lower legs 22 and 24 have spaced-apart holes 114 placed along their longitudinal length. The overall length of handle assembly 10 is adjusted by telescoping upper and lower legs 22 and 24 to a desired position where holes 114 line up and then placing pin 116 through holes 114 thereby fixing the leg length. Pin clip 118 secures 116 to keep it from falling out.

Referring to FIG. 19, an embodiment of the present invention for use with broom 92 is shown. In this embodiment, bracket 32 is fastened to the top of broom head 93 using conventional fasteners such as screws, bolts or nails (not shown). Alternatively, bracket 32 is attached to broom 92 by passing U-bolt 80 around the shaft of broom 92 and through apertures 44A and B of bracket 32 to be secured by nuts 82. Handle assembly 10 can than be attached to bracket 32 in the manner previously described herein.

Referring to FIG. 20, an embodiment of the present invention for use with floor squeegee 94 is shown. In this embodiment, bracket 32 is attached to squeegee 94 by passing U-bolt 80 around the shaft of squeegee 94 and through apertures 44A and B of bracket 32 to be secured by nuts 82. Handle assembly 10 can than be attached to bracket 32 in the manner previously described herein.

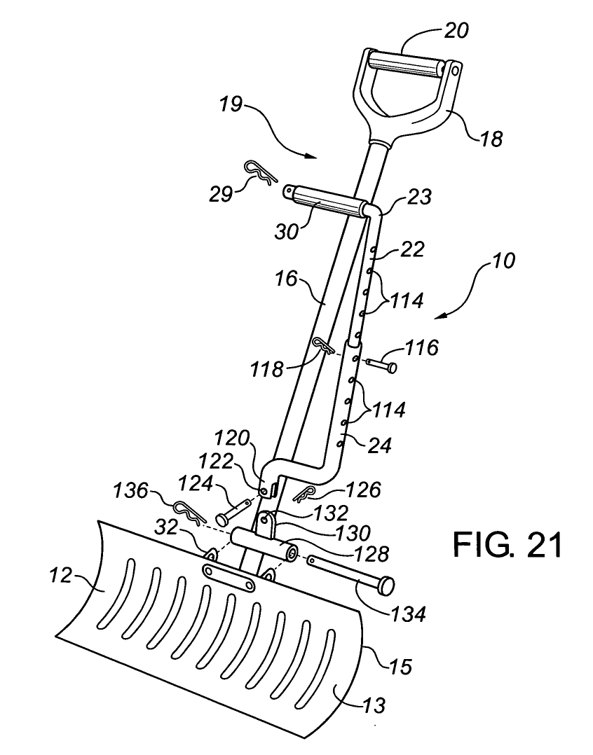

The preferred embodiment of handle assembly 10 comprises two substantially parallel leg members although an alternate embodiment of handle assembly 10 may comprise a single inverted L-shaped leg member. Illustrated in FIGS. 21, 22 and 23 are three embodiments of the present invention comprising a single leg member. It is anticipated that these alternate embodiments are nearly as effective as the preferred embodiments described above.

In FIG. 21, a universal joint attachment mechanism is illustrated. In this embodiment, U-joint 128 is attached to bracket 32 with pin 134 which is secured by pin clip 136. This allows U-joint 128 to rotate about the longitudinal axis of pin 134. Lower leg 24 is attached to flange 130 of U-joint 128 by passing pin 124 through holes 122 of yoke 120 and hole 132 of flange 130. Pin 124 is then secured by pin clip 126. This allows lower leg 24 to rotate side to side about the longitudinal axis of pin 124. This arrangement allows handle assembly 10 to pivot in all directions about the point where U-joint 128 is attached to bracket 32.

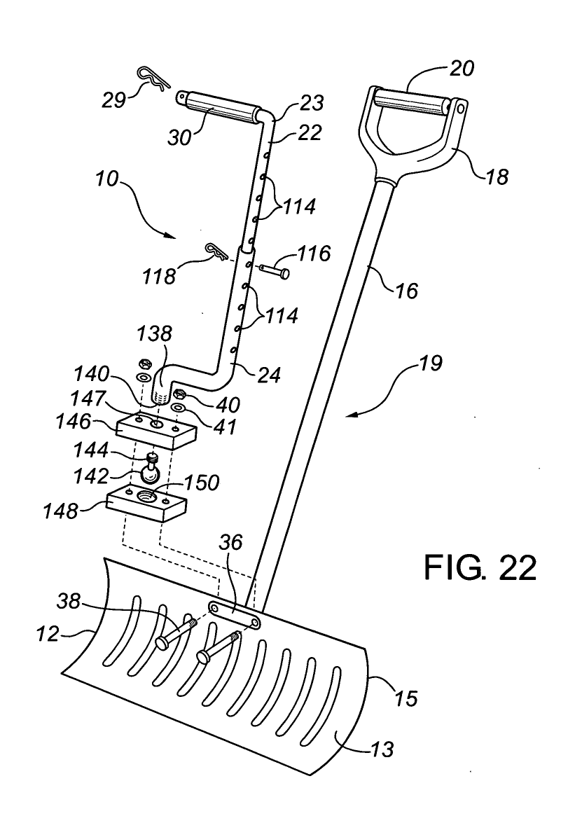

In FIG. 22, a ball joint attachment mechanism is illustrated, which provides similar functionality as the embodiment shown in FIG. 21. In this embodiment, base block 148 replaces bracket 32. Ball joint 142 sits in concave hollow 150 of base block 148. Threaded end 144 of ball joint 142 passes through hole 147 of cover block 146. A similar concave hollow (not shown) is positioned on the underside of cover block 147 to match the curvature of ball joint 142. Bolts 38 pass through backing plate 36, blade 12, base block 148 and cover block 146 to be secured by nuts 40. End 138 of lower leg 24 has internal threads 140 that thread onto threaded end 144 of ball joint 142. Once assembled, this embodiment also allows handle assembly 10 to pivot in all directions about the point where the ball joint assembly is attached to blade 12.

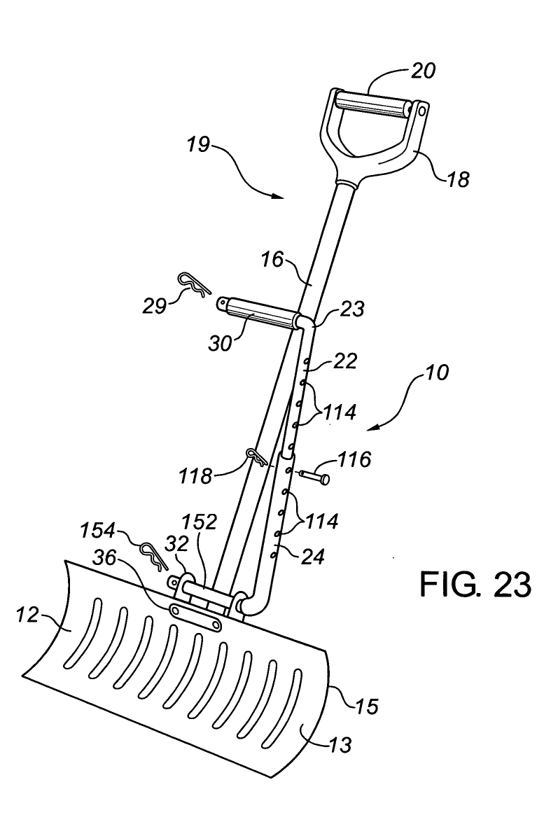

In FIG. 23, another single leg embodiment of handle assembly 10 is shown. In this embodiment, lower leg 24 is an L-shaped member having pivot rod 152. Pivot rod 152 passes through apertures 34 of bracket 32 and is secured by rod clip 154. This arrangement allows handle assembly 10 to pivot about the longitudinal axis of pivot rod 152. This embodiment provides similar stability and rigidity as the two-legged versions of handle assembly 10 described above.

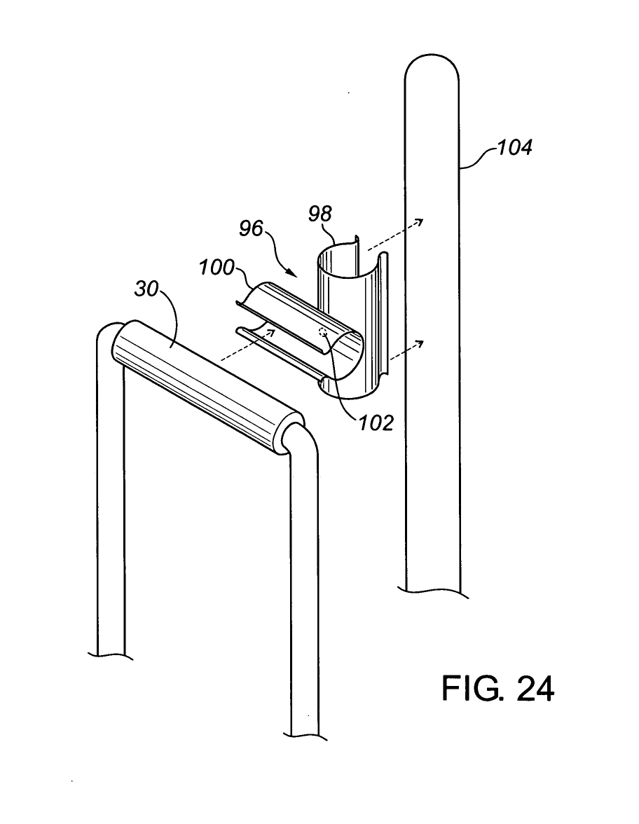

Referring to FIG. 24, a handle clip for securing handle assembly 10 to a hand tool. Handle clip 96 secures handle assembly 10 to the hand tool when the hand tool is put away for storage or when the hand tool is to used in a conventional manner without handle assembly 10. Handle clip 96 consists of two pieces, vertical clip 98 and horizontal clip 100, which are secured at point 102. Each clip is a horseshow or Omega-shaped piece of spring metal or resilient plastic that is sized to snuggly slip on to shaft 104 or grip 30 yet can be easily slipped off with minimal effort. Vertical clip 98 and horizontal clip 100 are fastened together at point 102 such that one clip is substantially orthogonal to the other. They may be spot welded together or fastened by a rivet. If handle clip 96 is made of plastic, both vertical clip 98 and horizontal clip 100 may be molded as a single unit. In operation, horizontal clip 100 snaps on to grip 30 of handle assembly 10 and is, preferably, 1″ to 1½″ in length. As handle assembly 10 is swung toward shaft 104 of a hand tool, vertical clip 98 snaps on to shaft 104. Vertical clip 98 is, preferably, 2″ to 2½″ in length. To use auxiliary handle assembly 10, grip 30 is simply pulled away from handle clip 96 releasing it from horizontal clip 100. Handle clip 96 may be left on shaft 104 as the hand tool is being used or removed and stored away separately.

In operation, a person grabs grip 30 of handle assembly 10 and the shaft of the hand tool with their hands. As the hand tool is swung backward or pushed forwards, grip 30 rotates on rods 31. This permits the person to keep their wrists stationary or in a locked position as handle assembly 10, in combination with the hand tool, is used to lift or move a load thereby reducing undue stress or strain on the wrists.

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized at the scope of the invention as defined and limited only by the claims that follow.

1. An auxiliary handle assembly for a hand tool having a longitudinal shaft with upper and lower ends, the lower end operatively attached to a tool head, the assembly comprising:
a) left and right pivot tabs operatively connected to said tool head, said pivot tabs defining a pivot axis;
b) an upper assembly comprising of left and right leg portions each having upper and lower ends, and a handle portion extending between said upper ends of said leg portions, said handle portion defining a handle axis, said lower ends of said leg portions adapted to pivotally attach to said pivot tabs whereby said upper assembly is capable of pivoting about said pivot axis; and
c) a hand grip pivotally attached to said handle portion, said hand grip capable of rotating about said handle axis.

2. The assembly as set forth in claim 1 further comprising a U-shaped bracket adapted to attach to said tool head with removable or permanent fasteners or by being welded to said tool head, said U-shaped bracket comprising said pivot tabs.

3. The assembly as set forth in claim 2 wherein the hand tool is a shovel, a snow shovel, a scoop, a rake, a rotary edger, a broom or a floor squeegee.

4. The assembly as set forth in claim 1 wherein said left and right pivot tabs are individual tabs attached separately to said tool head.

5. The assembly as set forth in claim 4 wherein said left and right tabs are adapted to attach to said tool head with removable or permanent fasteners or by being welded to said tool head.

6. The assembly as set forth in claim 4 wherein the hand tool is a fork, a hook, a cultivator, a shovel, a scoop, a scraper, an edger or a hoe.

7. The assembly as set forth in claim 1 wherein said pivot tabs form part of said tool head.

8. The assembly as set forth in claim 7 wherein the hand tool is a shovel, a scoop, a scraper, an edger or a hoe.

9. The assembly as set forth in claim 1 wherein the handle axis is substantially perpendicular to the leg portions.

10. The assembly as set forth in claim 9 wherein the leg portions and the handle portion are formed from an inverted U-shaped member and the hand grip is a tubular member that slides onto said U-shaped member prior to being formed into an inverted U-shape.

11. The assembly as set forth in claim 1 wherein the leg portions further comprise means for varying the length of said leg portions.

12. The assembly as set forth in claim 11 wherein the means for varying the length of the leg portions comprises each leg portion having upper and lower leg members, each lower leg member being a threaded rod, each upper leg member having a nut for receiving the threaded rod of the lower leg members whereby the overall length of each leg portion is determined by the amount the lower leg member is threaded into the nut of the upper leg member.

13. The assembly as set forth in claim 11 wherein the means for varying the length of the leg portions comprises each leg portion having upper leg members made of threaded rod with threads of one orientation and lower leg members made of threaded rod with threads of an opposite orientation, and a sleeve for each leg portion, the sleeve having two ends with internal threads of one orientation at one end and internal threads of the opposite orientation at the other end, each sleeve capable of coupling a pair of upper and lower leg members together whereby the overall length of each leg portion is determined by the amount each upper and lower leg member is threaded into its respective sleeve.

14. The assembly as set forth in claim 11 wherein the means for varying the length of the leg portions comprises each leg portion having upper and lower leg members made of threaded rod, and a coupling nut for each leg portion, the coupling nut having two nuts adjoined to one another side by side whereby an upper leg threads into one nut of the coupling nut from one end and a lower leg threads into the other nut of the coupler nut from the opposite end, and whereby the overall length of each leg portion is determined by the amount each upper and lower leg member is threaded into its respective coupling nut.

15. The assembly as set forth in claim 1 wherein the means for varying the length of the leg portions comprises each leg portion having telescoping upper and lower leg members that are slidably connected to one another, and means for securing the relative position of the upper and lower leg members to each other.

16. The assembly as set forth in claim 15 wherein said securing means comprises said upper and lower leg member having a plurality of spaced-apart apertures along the longitudinal length of said leg members, and a pin adapted to pass through said apertures of both upper and lower leg members thereby fixing the length of said leg portion.

17. The assembly as set forth in claim 1 further comprising a handle clip for removably attaching the hand grip of the auxiliary handle assembly to the shaft of the hand tool when said hand tool is not being used, the handle clip comprising:
a) a first clip having a first opening suitable for removably attaching to said shaft and a first back opposing said first opening; and
b) a second clip having a second opening suitable for removably attaching to said hand grip and a second back opposing said second opening, said second clip attached to said first clip whereby said first back is abutting said second back and whereby said first and second clips are substantially orthogonal to one another.

18. A handle clip for removably attaching a hand grip of an auxiliary handle assembly to a shaft of a hand tool, said auxiliary handle assembly pivotally attached to a tool head of said hand tool, said handle clip comprising:
a) a first clip having a first opening suitable for removably attaching to said shaft and a first back opposing said first opening; and
b) a second clip having a second opening suitable for removably attaching to said hand grip and a second back opposing said second opening, said second clip attached to said first clip whereby said first back is abutting said second back and whereby said first and second clips are substantially orthogonal to one another.

19. An auxiliary handle assembly for a hand tool having a longitudinal shaft with upper and lower ends, the lower end operatively attached to a tool head, the assembly comprising:
a) a pivot tab operatively connected to said tool head, said pivot tab defining a pivot point;
b) an upper assembly comprising of a leg portion having upper and lower ends, and a handle portion extending from the upper end of said leg portion, said handle portion defining a handle axis, said lower end of said leg portion adapted to pivotally attach to said pivot tab whereby said upper assembly is capable of pivoting about said pivot point; and
c) a hand grip pivotally attached to said handle portion, said hand grip capable of rotating about said handle axis.

20. The assembly as set forth in claim 19 wherein said pivot tab further comprises a bracket adapted to attach to said tool head with removable or permanent fasteners or by being welded to said tool head or by being made part of said tool head, and a U-joint member pivotally connecting said leg portion to said tool head.

21. The assembly as set forth in claim 20 wherein the hand tool is a shovel, a snow shovel, a scoop, a rake, an edger, a rotary edger, a hoe, a fork, a hook, a cultivator, a broom or a floor squeegee.

22. The assembly as set forth in claim 19 wherein said pivot tab comprises a ball joint mechanism pivotally connecting said leg portion to said tool head.

23. The assembly as set forth in claim 22 wherein the hand tool is a shovel, a snow shovel, a scoop, a rake, an edger, a rotary edger, a hoe, a fork, a hook, a cultivator, a broom or a floor squeegee.

24. The assembly as set forth in claim 19 wherein the handle axis is substantially perpendicular to the leg portion.

25. The assembly as set forth in claim 24 wherein the upper end of said leg portion and the handle portion form an inverted L-shaped member and the hand grip is a tubular member that slides onto and is rotably attached to said handle portion.

26. The assembly as set forth in claim 24 wherein the leg portion further comprises means for varying the length of said leg portion.

27. The assembly as set forth in claim 26 wherein the means for varying the length of the leg portion comprises the leg portion having upper and lower leg members, the lower leg member being a threaded rod, the upper leg member having a nut for receiving the threaded rod of said lower leg member whereby the overall length of the leg portion is determined by the amount the lower leg member is threaded into said nut of said upper leg member.

28. The assembly as set forth in claim 26 wherein the means for varying the length of the leg portion comprises the leg portion having a upper leg member made of threaded rod with threads of one orientation and a lower leg member made of threaded rod with threads of an opposite orientation, and a sleeve having two ends with internal threads of one orientation at one end and internal threads of the opposite orientation at the other end, said sleeve capable of coupling the upper and lower leg members together whereby the overall length of said leg portion is determined by the amount each upper and lower leg member is threaded into said sleeve.

29. The assembly as set forth in claim 26 wherein the means for varying the length of the leg portion comprises said leg portion having upper and lower leg members made of threaded rod, and a coupling nut having two nuts adjoined to one another side by side whereby an upper leg threads into one nut of the coupling nut from one end and a lower leg threads into the other nut of the coupler nut from the opposite end, and whereby the overall length of said leg portion is determined by the amount each upper and lower leg member is threaded into said coupling nut.

30. The assembly as set forth in claim 26 wherein the means for varying the length of the leg portion comprises the leg portion having telescoping upper and lower leg members that are slidably connected to one another, and means for securing the relative position of the upper and lower leg members to each other.

31. The assembly as set forth in claim 30 wherein said securing means comprises said upper and lower leg member having a plurality of spaced-apart apertures along the longitudinal length of said leg members, and a pin adapted to pass through said apertures of both upper and lower leg members thereby fixing the length of said leg portion.
